(19) United States
(12) Patent Application Publication
(10) Pub. No.: US 2026/0058331 A1
(43) Pub. Date: Feb. 26, 2026

(54) BATTERY CELL AND BATTERY MODULE

(71) Applicant: SUNWODA MOBILITY ENERGY TECHNOLOGY CO., LTD., Guangdong (CN)

(72) Inventor: Lun XU, Guangdong (CN)

(73) Assignee: SUNWODA MOBILITY ENERGY TECHNOLOGY CO., LTD., Guangdong (CN)

(21) Appl. No.: 19/375,213

(22) Filed: Oct. 31, 2025

Related U.S. Application Data
(63) Continuation of application No. PCT/CN2023/141909, filed on Dec. 26, 2023.

(30) Foreign Application Priority Data
Jun. 27, 2023 (CN) 202321652732.X

(51) Int. Cl. H01M 50/533; H01M 10/0587

(52) U.S. Cl. CPC H01M 50/533; H01M 10/0587

(57) ABSTRACT

A battery cell and a battery module. The battery cell includes: a housing and an electrode assembly accommodated in the housing, where the electrode assembly includes a positive electrode sheet, a separator and a negative electrode sheet, which are arranged to be mutually stacked, the separator is arranged between the positive electrode sheet and the negative electrode sheet, and the separator is provided with a first edge and a second edge arranged opposite to each other in a first direction X; the positive electrode sheet is connected to a positive electrode tab; the negative electrode sheet is connected to a negative electrode tab; the positive electrode tab is provided with a third edge away from the positive electrode sheet in the first direction X; the negative electrode tab is provided with a fourth edge away from the negative electrode sheet in the first direction X.

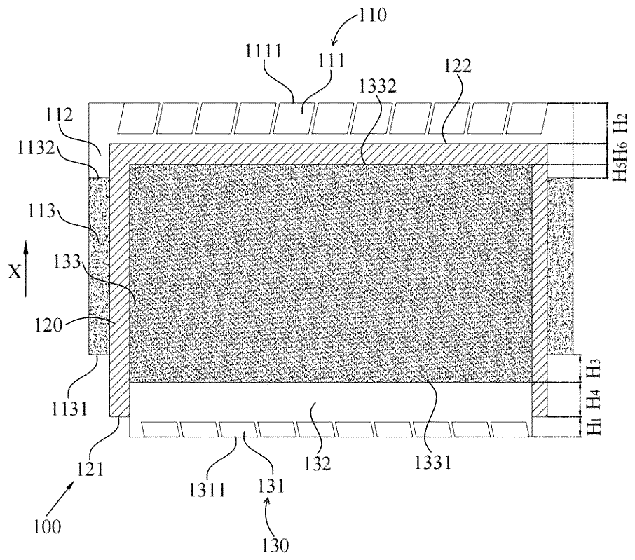

### CROSS-REFERENCE TO RELATED APPLICATION

This application is a continuation of International Application of PCT application serial no. PCT/CN2023/141909 filed on Dec. 26, 2023, which claims the priority benefit of China application serial no. 202321652732.X filed on Jun. 27, 2023. The entirety of each of the above-mentioned patent applications is hereby incorporated by reference herein and made a part of this specification.

### BACKGROUND

### Technical Field

The embodiments of the present application relate to, but are not limited to, a battery cell and a battery module.

### Description of Related Art

With the rapid development of electric devices such as mobile phone, laptop, electric vehicle, and electric tool, a secondary battery with high energy density, long cycle life, and high safety performance has been widely applied and developed. At the same time, large cylindrical secondary battery has also gained extensive application due to its superior properties of low internal resistance and high energy density. However, the energy density of large cylindrical secondary battery is relatively low.

### SUMMARY

### Technical Problem

The present application provides a battery cell and a battery module to improve the energy density of the battery.

### Technical Solution

In a first aspect, the present application provides a battery cell having a first direction and including: a housing; and
an electrode assembly, accommodated in the housing;
where the electrode assembly includes: a positive electrode sheet, a separator and a negative electrode sheet which are arranged to be mutually stacked; the separator is arranged between the positive electrode sheet and the negative electrode sheet, and the separator is provided with a first edge and a second edge arranged opposite to each other in the first direction;
the positive electrode sheet is connected to a positive electrode tab; the negative electrode sheet is connected to a negative electrode tab;
where the positive electrode tab is provided with a third edge away from the positive electrode sheet in the first direction, and the first edge is farther away from the third edge than the second edge;
the negative electrode tab is provided with a fourth edge away from the negative electrode sheet in the first direction, and the second edge is farther away from the fourth edge than the first edge; and
in the first direction, a distance between the first edge and the fourth edge is H₁ mm, and a distance between the second edge and the third edge is H₂ mm, satisfying: H₁<H₂.

In some embodiments, the distance H₁ mm between the first edge and the fourth edge and the distance H₂ mm between the second edge and the third edge further satisfy: 0.2≤H₂-H₁≤5.

In some embodiments, the distance H₁ mm between the first edge and the fourth edge and the distance H₂ mm between the second edge and the third edge further satisfy: 0.5≤H₂-H_{1≤1.5.}

In some embodiments, the distance H₁ mm between the first edge and the fourth edge further satisfies: 0<H₁≤3.

In addition to one or more features disclosed above, or as an alternative, the distance H₁ mm between the first edge and the fourth edge further satisfies: 0<H₁≤1.5.

In some embodiments, the distance H₂ mm between the second edge and the third edge further satisfies: 0<H₂≤8.

In some embodiments, the distance H₂ mm between the second edge and the third edge further satisfies: 0<H₂≤3.

In some embodiments, the positive electrode sheet includes: a positive electrode substrate; and a positive electrode active material layer arranged on the positive electrode substrate;

the negative electrode sheet includes: a negative electrode substrate; and a negative electrode active material layer arranged on the negative electrode substrate;

the positive electrode active material layer is provided with a fifth edge away from the positive electrode tab in the first direction, and the negative electrode active material layer is provided with a seventh edge away from the positive electrode tab in the first direction;
a distance between the fifth edge and the seventh edge is H₃ mm, satisfying: 0<H₃≤3;
a distance between the seventh edge and the first edge is H₄ mm, satisfying: 0<H₄≤3.

In some embodiments, the distance H₃ mm between the fifth edge and the seventh edge further satisfies: 0.2≤H₃≤2; and
the distance H₄ mm between the seventh edge and the first edge further satisfies: 0.2≤ H₄≤2.

In some embodiments, the positive electrode active material layer is further provided with a sixth edge close to the positive electrode tab in the first direction;
the negative electrode active material layer is further provided with an eighth edge close to the positive electrode tab in the first direction;
a distance between the sixth edge and the eighth edge is H₅ mm, satisfying: 0<H₅≤3;
a distance between the eighth edge and the second edge is H₆ mm, satisfying: 0<H₆≤3.

In some embodiments, the distance H₅ mm between the sixth edge and the eighth edge further satisfies: 0.2≤H₅≤2; and
the distance H₆ mm between the eighth edge and the second edge further satisfies: 0.2≤H₆≤2.

In a second aspect, the present application provides a battery module comprising a box body; and the battery cell as described above, where the battery cell is accommodated in the box body.

### Beneficial Effects

In the present application, by controlling the distance H₁ between the first edge and the fourth edge to be smaller than the distance H₂ between the second edge and the third edge, the distance between the first edge and the fourth edge is reduced, so that an increase of the height occupied by the regions of the active material on the positive electrode sheet and the negative electrode sheet, and an increase of the area of the active material on the positive electrode sheet and the negative electrode sheet can be ensured under a given battery height, so as to improve the utilization rate of the active material in terms of height space in the battery, thereby enhancing the energy density of the battery.

### BRIEF DESCRIPTION OF THE DRAWINGS

In order to more clearly illustrate the technical solutions in the embodiments of the present application, the drawings required for use in the description of the embodiments will be briefly introduced below. Obviously, the drawings described below are only some embodiments of the present application. For those skilled in the art, other drawings may be obtained based on these drawings without creative work.

Figure is a structural view of a battery cell provided according to an embodiment of the present application.

### DESCRIPTION OF THE EMBODIMENTS

The present application provides a battery cell and a battery module. In order to make the objectives, technical solutions and effects of the present application clearer and more specific, the present application is further described in detail in conjunction with the embodiments below. It should be understood that the specific embodiments described here are only used to explain the present application and are not intended to limit the present application.

For large cylindrical batteries, after the electrode assembly is wound, a flattening operation is performed on the positive electrode tab and negative electrode tab. On one hand, the flatness of the flattened surfaces of positive electrode tab and negative electrode tab can be ensured, facilitating the subsequent welding between the tab and the current collector plate. On the other hand, the distance between the flattened surface of the positive electrode tab and the separator, as well as the distance between the flattened surface of the negative electrode tab and the separator, can be controlled, thereby controlling the height of the electrode assembly and facilitating assembling of the electrode assembly into the housing.

The flattening process of large cylindrical battery is to maintain the distance between the flattened surface of the positive electrode tab and the separator to be consistent with the distance between the flattened surface of the negative electrode tab and the separator. However, since the fluctuation tolerance of the positive electrode tab will be larger than that of the negative electrode tab, when the flattening is performed under the condition of maintaining the distance between the flattened surface of the positive electrode tab and the separator, the distance between the flattened surface of the negative electrode tab and the separator becomes overly large, thereby reducing the utilization rate of the active material in terms of height space and reducing the energy density of the battery.

The present application provides a battery cell to improve the utilization rate of the active material in the battery in terms of height space, thereby enhancing the energy density of the battery.

In an embodiment of the present application, referring to the figure, the present application provides a battery cell 100, and the battery cell 100 has a first direction X and may include: a housing; and an electrode assembly accommodated in the housing.

Specifically, the aforementioned electrode assembly includes: a positive electrode sheet 110, a separator 120 and a negative electrode sheet 130 which are arranged to be mutually stacked, where the separator 120 is arranged between the positive electrode sheet 110 and the negative electrode sheet 130, and the separator 120 is provided with a first edge 121 and a second edge 122 that are arranged opposite to each other in a first direction X; the positive electrode sheet 110 is connected to a positive electrode tab 111; the negative electrode sheet 130 is connected to a negative electrode tab 131; the positive electrode tab 111 is provided with a third edge 1111 away from the positive electrode sheet 110 in the first direction X, and the first edge 121 is farther away from the third edge 1111 than the second edge 122; the negative electrode tab 131 is provided with a fourth edge 1311 away from the negative electrode sheet 130 in the first direction X, and the second edge 122 is farther away from the fourth edge 1311 than the first edge 121.

Where, after the positive electrode sheet 110, the separator 120 and the negative electrode sheet 130 are wound to form an electrode assembly, the positive electrode tab 111 and the negative electrode tab 131 may be processed by using a flattening process without cutting tabs, or a flattening process with cutting tabs, which is not specifically limited in the present application, and the specific selection may be made according to actual needs, as long as it does not affect the effects of the present application.

Where, the present application imposes no restrictions on the dimensions such as height, width and gap, and morphology of the positive electrode tab 111 and the negative electrode tab 131. For example, the dimensions such as height, width and gap, and morphology of the positive electrode tab 111 and the negative electrode tab 131 may adopt a conventional design; for another example, a special structural design may be applied to one or more of the dimensions such as height, width and gap, and morphology of the positive electrode tab 111 and the negative electrode tab 131, as long as it does not affect the effects of the present application.

Further, in the first direction X, a distance between the first edge 121 and the fourth edge 1311 is H₁ mm, and a distance between the second edge 122 and the third edge 1111 is H₂ mm, satisfying: H₁<H₂.

Where, “first”, “second”, “third” and “fourth” in the first edge 121, the second edge 122, the third edge 1111 and the fourth edge 1311 are only for distinguishing different edges, which are not restrictions on the number or order of the edges.

Where, in the present application, by reducing the distance H between the first edge 121 and the fourth edge 1311 during the design of the battery, H₁<H₂ is satisfied for the relationship between H₁ and H₂.

Where, the distance H₁ between the first edge 121 and the fourth edge 1311 may be obtained by measuring the distances between the first edge 121 and the fourth edge 1311 at different positions multiple times with a measuring tool and calculating an average value. The measuring tool may be any one of a straightedge or a vernier caliper, but is not limited thereto.

Where, the distance H₂ between the second edge 122 and the third edge 1111 may be obtained by measuring the distances between the second edge 122 and the third edge 1111 at different positions multiple times with a measuring tool and calculating an average value. The measuring tool may be any one of a straightedge or a vernier caliper, but is not limited thereto.

It can be understood that in the present application, by controlling the distance H₁ between the first edge 121 and the fourth edge 1311 to be smaller than the distance H₂ between the second edge 122 and the third edge 1111, the distance between the first edge 121 and the fourth edge 1311 is reduced, so that an increase of the height occupied by the regions of the active material on the positive electrode sheet and the negative electrode sheet, and an increase of the area of the active material on the positive electrode sheet and the negative electrode sheet can be ensured under a given battery height, so as to improve the utilization rate of the active material in terms of height space in the battery, thereby enhancing the energy density of the battery.

Further, in one embodiment, the distance H₁ mm between the first edge 121 and the fourth edge 1311 and the distance H₂ mm between the second edge 122 and the third edge 1111 also satisfy: 0.2<H₂-H₁≤5. That is, the difference between the distance H₁ between the first edge 121 and the fourth edge 1311 and the distance H₂ between the second edge 122 and the third edge 1111 can be controlled within a range of 0.2-5 mm. For example, H₂-H₁ may be one of 0.2 mm, 0.5 mm, 1 mm, 1.5 mm, 2 mm, 2.5 mm, 3 mm, 3.5 mm, 4 mm, 4.5 mm, and 5 mm, or a range consisting of any two thereof. It is worth noting that the above specific numerical values of the difference H₂-H₁ are only given as examples, and any value within the range of 0.2-5 mm is within the protection scope of the present application.

In one embodiment, the distance H₁ mm between the first edge 121 and the fourth edge 1311 and the distance H₂ mm between the second edge 122 and the third edge 1111 also satisfy: 0.5≤H₂-H₁≤1.5. That is, the difference between the distance H₁ between the first edge 121 and the fourth edge 1311 and the distance H₂ between the second edge 122 and the third edge 1111 can be controlled within a range of 0.5-1.5 mm. For example, H₂-H₁ may be one of 0.5 mm, 0.6 mm, 0.7 mm, 0.8 mm, 0.9 mm, 1 mm, 1.1 mm, 1.2 mm, 1.3 mm, 1.4 mm, and 1.5 mm, or a range consisting of any two thereof. It is worth noting that the above specific numerical values of the difference H₂-H₁ are only given as examples, and any value within the range of 0.5-1.5 mm is within the protection scope of the present application.

In the present application, by controlling the difference between the distance H₂ between the second edge 122 and the third edge 1111 and the distance H₁ between the first edge 121 and the fourth edge 1311 within the range of 0.5-1.5 mm, an increase of the height occupied by the active material regions on the positive electrode sheet and the negative electrode sheet, and an increase of the area of the active material on the positive electrode sheet and the negative electrode sheet can be further ensured under a given battery height, so as to improve the utilization rate of the active material in terms of height space in the battery, thereby enhancing the energy density of the battery.

In an embodiment of the present application, the distance H₁ mm between the first edge 121 and the fourth edge 1311 also satisfies: 0<H₁<3. That is, the distance H₁ between the first edge 121 and the fourth edge 1311 may be controlled within a range of 0-3 mm. For example, the distance H₁ between the first edge 121 and the fourth edge 1311 may be one of 0.2 mm, 0.6 mm, 1 mm, 1.4 mm, 1.8 mm, 2.2 mm, 2.6 mm, and 3 mm, or a range consisting of any two thereof. It is worth noting that the above specific numerical values of the distance H₁ are only given as examples, and any value within the range of 0-3 mm is within the protection scope of the present application.

In one embodiment, the distance H₁ mm between the first edge 121 and the fourth edge 1311 also satisfies: 0<H₁≤1.5. That is, the distance H₁ between the first edge 121 and the fourth edge 1311 may be controlled within a range of 0-1.5 mm. For example, the distance H₁ between the first edge 121 and the fourth edge 1311 may be one of 0.2 mm, 0.4 mm, 0.6 mm, 0.8 mm, 1 mm, 1.2 mm, 1.4 mm, and 1.5 mm, or a range consisting of any two thereof. It is worth noting that the above specific numerical values of the distance H₁ are only given as examples, and any value within the range of 0-1.5 mm is within the protection scope of the present application.

It can be understood that in the present application, by controlling the distance H₁ between the first edge 121 and the fourth edge 1311 within a range of 0-1.5 mm, an increase of the height occupied by the region of the active material on the negative electrode sheet, and an increase of the area of the active material on the negative electrode sheet can be further ensured under a given battery height, so as to improve the utilization rate of the active material in terms of the height space in the battery, thereby enhancing the energy density of the battery.

In an embodiment of the present application, the distance H₂ mm between the second edge 122 and the third edge 1111 also satisfies: 0<H₂≤8. That is, the distance H₂ between the second edge 122 and the third edge 1111 may be controlled within a range of 0-8 mm. For example, the distance H₂ between the second edge 122 and the third edge 1111 may be one of 0.1 mm, 1 mm, 2 mm, 3 mm, 4 mm, 5 mm, 6 mm, 7 mm, and 8 mm, or a range consisting of any two thereof. It is worth noting that the above specific numerical values of the distance H₂ are only given as examples, and any value within the range of 0-8 mm is within the protection scope of the present application.

In one embodiment, the distance H₂ mm between the second edge 122 and the third edge 1111 also satisfies: 0<H₂≤3. That is, the distance H₂ between the second edge 122 and the third edge 1111 may be controlled within a range of 0-3 mm. For example, the distance H₂ between the second edge 122 and the third edge 1111 may be one of 0.2 mm, 0.6 mm, 1 mm, 1.4 mm, 1.8 mm, 2.2 mm, 2.6 mm, and 3 mm, or a range consisting of any two thereof. It is worth noting that the above specific numerical values of the distance H₂ are only given as examples, and any value within the range of 0-3 mm is within the protection scope of the present application.

In the present application, by controlling the distance H₂ between the second edge 122 and the third edge 1111 within the range of 0-3 mm, an increase of the height occupied by the region of the active material on the positive electrode sheet, and an increase of the area of the active material on the positive electrode sheet can be further ensured under a given battery height, so as to improve the utilization rate of the active material in terms of the height space in the battery, thereby enhancing the energy density of the battery.

In an embodiment of the present application, the positive electrode sheet 110 includes: a positive electrode substrate 112; and a positive electrode active material layer 113 arranged on the positive electrode substrate 112.

Specifically, the aforementioned positive electrode active material layer 113 may be arranged as a single layer or multiple layers, and each layer in the multiple layers of the positive electrode active material may include the same positive electrode active material or different positive electrode active materials. The positive electrode active material is any substance capable of reversibly intercalating and deintercalating metal ions such as lithium ions.

The positive electrode active material layer 113 includes, but is not limited to, positive electrode active material. The positive electrode active material includes, but not limited to, lithium cobalt oxide, lithium manganese oxide, lithium iron phosphate (LFP) and ternary material. Ternary material includes, but is not limited to, lithium nickel cobalt manganese oxide and lithium nickel cobalt aluminum oxide.

The positive electrode active material may also include a doping element. The aforementioned doping element may include aluminum, magnesium, titanium, zirconium and the like, as long as the structure of the positive electrode active material can be made more stable. The positive electrode active material may also include a coating element. The aforementioned coating element may include aluminum, magnesium, titanium, zirconium and the like, as long as the structure of the positive electrode active material can be made more stable.

Further, in the present application, there is no specific restriction on the type of the positive electrode substrate 112, which may be any known material suitable for use as the positive electrode substrate 112, as long as it does not impair the effects of the present application.

Specifically, in one embodiment, the positive electrode substrate 112 may include, but is not limited to, metal materials such as aluminum, stainless steel, nickel plating, titanium, tantalum; and carbon materials such as carbon cloth and carbon paper. In one embodiment, the positive electrode substrate 112 is a metal material. In one embodiment, the positive electrode substrate is aluminum foil.

In one embodiment, the positive electrode sheet 110 also includes a positive electrode conductive agent and a positive electrode binder. In the present application, there is no restrictions on the types of the positive electrode conductive agent and the positive electrode binder, and any known material may be used, as long as it does not impair the effects of the present application.

The positive electrode sheet 110 in the battery cell 100 of the present application may be prepared by using any known method. For example, a conductive agent, a binder, a solvent, etc., are added to the positive electrode active material to form a slurry; and the slurry is coated on the positive electrode substrate, and after drying, it is pressed to form an electrode. The negative electrode active material may also be roll-formed to produce a sheet-like electrode, or compressed and molded to produce a granular electrode.

Further, the negative electrode sheet 130 includes: a negative electrode substrate 132; and a negative electrode active material layer 133 arranged on the negative electrode substrate 132.

Specifically, the negative electrode substrate 132 includes, but is not limited to, metal foil, metal cylinder, metal strip, metal plate, metal film, expanded metal mesh, stamped metal, foamed metal, and the like. In one embodiment, the negative electrode substrate 132 is a metal foil. In one embodiment, the negative electrode substrate 132 is a copper foil. As used herein, the term “copper foil” includes copper alloy foil.

The negative electrode active material layer 133 may be a single layer or multiple layers, and each layer in the multiple layers of negative electrode active material may include the same negative electrode active material or different negative electrode active materials. In an embodiment of the present application, the chargeable capacity of the negative electrode active material is greater than the discharge capacity of the positive electrode active material, so as to prevent lithium metal from precipitating on the negative electrode sheet during charging.

The negative electrode active material layer 133 includes, but is not limited to, artificial graphite, natural graphite, soft carbon, hard carbon, amorphous carbon, carbon fiber, carbon nanotube and mesophase carbon microsphere. The aforementioned negative electrode active materials may be used alone or in any combination.

The negative electrode sheet 130 in the battery cell 100 of the present application may be prepared by using any known method. For example, a conductive agent, a binder, an additive, a solvent, etc., are added to the negative electrode active material to prepare a slurry; and the slurry is coated on the negative electrode substrate, and after drying, it is pressed to form an electrode.

Further, in one embodiment, the positive electrode active material layer 113 is provided with a fifth edge 1131 away from the positive electrode tab 111 in the first direction X, and the negative electrode active material layer 133 is provided with a seventh edge 1331 away from the positive electrode tab 111 in the first direction X.

Where, the “fifth” in the fifth edge 1131 and the “seventh” in the seventh edge 1331 are only for distinguishing different edges, which are not restrictions on the number or order of the edges.

Specifically, a distance between the fifth edge 1131 and the seventh edge 1331 is H₃ mm, satisfying: 0<H₃≤3; that is, the distance H₃ between the fifth edge 1131 and the seventh edge 1331 may be controlled within a range of 0-3 mm. For example, the distance H₃ between the fifth edge 1131 and the seventh edge 1331 may be one of 0.2 mm, 0.6 mm, 1 mm, 1.4 mm, 1.8 mm, 2.2 mm, 2.6 mm, and 3 mm, or a range consisting of any two thereof. It is worth noting that the above specific numerical values of the distance H₃ are only given as examples, and any value within the range of 0-3 mm is within the protection scope of the present application.

In one embodiment, the distance H₃ mm between the fifth edge 1131 and the seventh edge 1331 also satisfies: 0.2≤H₃<2; that is, the distance Ha between the fifth edge 1131 and the seventh edge 1331 may be controlled within a range of 0.2-2 mm. For example, the distance H₃ between the fifth edge 1131 and the seventh edge 1331 may be 0.2 mm, 0.4 mm, 0.6 mm, 0.8 mm, 1 mm, 1.2 mm, 1.4 mm, 1.6 mm, 1.8 mm, and 2 mm, or a range consisting of any two thereof. It is worth noting that the above specific numerical values of the distance H₃ are only given as examples, and any value within the range of 0.2-2 mm is within the protection scope of the present application.

Where, the distance H₃ between the fifth edge 1131 and the seventh edge 1331 may be obtained by measuring the distances between the fifth edge 1131 and the seventh edge 1331 at different positions multiple times with a measuring tool and calculating an average value. The measuring tool may be any one of a straightedge or a vernier caliper, but is not limited thereto. In the present application, by controlling the distance H₃ between the fifth edge 1131 and the seventh edge 1331 within the range of 0.2-2 mm, an increase of the height occupied by the regions of the active material on the positive electrode sheet and negative electrode sheet, and an increase of the area of the active materials on the positive electrode sheet and negative electrode sheet can be further ensured under a given battery height, so as to improve the utilization rate of the active material in terms of the height space in the battery, thereby enhancing the energy density of the battery.

Specifically, a distance between the seventh edge 1331 and the first edge 121 is H₄ mm, satisfying: 0<H₄<3. That is, the distance H₄ between the seventh edge 1331 and the first edge 121 may be controlled within a range of 0-3 mm. For example, the distance H₄ between the seventh edge 1331 and the first edge 121 may be one of 0.2 mm, 0.6 mm, 1 mm, 1.4 mm, 1.8 mm, 2.2 mm, 2.6 mm, and 3 mm, or a range consisting of any two thereof. It is worth noting that the above specific numerical values of the distance H₄ are only given as examples, and any value within the range of 0-3 mm is within the protection scope of the present application.

In one embodiment, the distance H₄ mm between the seventh edge 1331 and the first edge 121 also satisfies: 0.2≤H₄≤2. That is, the distance H₄ between the seventh edge 1331 and the first edge 121 may be controlled within a range of 0.2-2 mm. For example, the distance H₄ between the seventh edge 1331 and the first edge 121 may be 0.2 mm, 0.4 mm, 0.6 mm, 0.8 mm, 1 mm, 1.2 mm, 1.4 mm, 1.6 mm, 1.8 mm, and 2 mm, or a range consisting of any two thereof. It is worth noting that the above specific numerical values of the distance H₄ are only given as examples, and any value within the range of 0.2-2 mm is within the protection scope of the present application.

Where, the distance H₄ between the seventh edge 1331 and the first edge 121 may be obtained by measuring the distances between the seventh edge 1331 and the first edge 121 at different positions multiple times with a measuring tool and calculating an average value. The measuring tool may be any one of a straightedge or a vernier caliper, but is not limited thereto.

In the present application, by controlling the distance H₄ between the seventh edge 1331 and the first edge 121 within a range of 0.2-2 mm, an increase of the height occupied by the region of the active material on the negative electrode sheet, and an increase of the area of the active material on the negative electrode sheet can be further ensured under a given battery height, so as to improve the utilization rate of the active material in terms of the height space in the battery, thereby enhancing the energy density of the battery.

In an embodiment of the present application, the positive electrode active material layer 113 is further provided with a sixth edge 1132 close to the positive electrode tab 111 in the first direction X; the negative electrode active material layer 133 is further provided with an eighth edge 1332 close to the positive electrode tab 111 in the first direction X.

Where, the “sixth” in the sixth edge 1132 and the “eighth” in the eighth edge 1332 are only for distinguishing different edges, which are not restrictions on the number or order of the edges.

Specifically, a distance between the sixth edge 1132 and the eighth edge 1332 is H₅ mm, satisfying: 0<H₅≤3. That is, the distance H₅ between the sixth edge 1132 and the eighth edge 1332 may be controlled within a range of 0-3 mm. For example, the distance H₅ between the sixth edge 1132 and the eighth edge 1332 may be one of 0.2 mm, 0.6 mm, 1 mm, 1.4 mm, 1.8 mm, 2.2 mm, 2.6 mm, and 3 mm, or a range consisting of any two thereof. It is worth noting that the above specific numerical values of the distance H₅ are only given as examples, and any value within the range of 0-3 mm is within the protection scope of the present application.

In one embodiment, the distance H₅ mm between the sixth edge 1132 and the eighth edge 1332 also satisfies: 0.2≤H₅<2. That is, the distance H₅ between the sixth edge 1132 and the eighth edge 1332 may be controlled within a range of 0.2-2 mm. For example, the distance H₅ between the sixth edge 1132 and the eighth edge 1332 may be one of 0.2 mm, 0.4 mm, 0.6 mm, 0.8 mm, 1 mm, 1.2 mm, 1.4 mm, 1.6 mm, 1.8 mm, and 2 mm, or a range consisting of any two thereof. It is worth noting that the above specific numerical values of the distance H₅ are only given as examples, and any value within the range of 0.2-2 mm is within the protection scope of the present application.

Where, the distance H₅ between the sixth edge 1132 and the eighth edge 1332 may be obtained by measuring the distances between the sixth edge 1132 and the eighth edge 1332 at different positions multiple times with a measuring tool and calculating an average value. The measuring tool may be any one of a straightedge or a vernier caliper, but is not limited thereto.

In the present application, by controlling the distance H₅ between the sixth edge 1132 and the eighth edge 1332 within the range of 0.2-2 mm, an increase of the height occupied by the regions of the active material on the positive electrode sheet and the negative electrode sheet, and an increase of the area of the active material on the positive electrode sheet and the negative electrode sheet can be further ensured under a given battery height, so as to improve the utilization rate of the active material in terms of the height space in the battery, thereby enhancing the energy density of the battery.

Further, a distance between the eighth edge 1332 and the second edge 122 is H₆ mm, satisfying: 0<H₆≤3. That is, the distance H₆ between the eighth edge 1332 and the second edge 122 may be controlled within a range of 0-3 mm. For example, the distance H₆ between the eighth edge 1332 and the second edge 122 may be one of 0.2 mm, 0.6 mm, 1 mm, 1.4 mm, 1.8 mm, 2.2 mm, 2.6 mm, and 3 mm, or a range consisting of any two thereof. It is worth noting that the above specific numerical values of the distance H₆ are only given as examples, and any value within the range of 0-3 mm is within the protection scope of the present application.

In one embodiment, the distance H₆ mm between the eighth edge 1332 and the second edge 122 also satisfies: 0.2≤H₆≤2. That is, the distance H₆ between the eighth edge 1332 and the second edge 122 may be controlled within a range of 0.2-2 mm. For example, the distance H₆ between the eighth edge 1332 and the second edge 122 may be one of 0.2 mm, 0.4 mm, 0.6 mm, 0.8 mm, 1 mm, 1.2 mm, 1.4 mm, 1.6 mm, 1.8 mm, and 2 mm, or a range consisting of any two thereof. It is worth noting that the above specific numerical values of the distance H₆ are only given as examples, and any value within the range of 0.2-2 mm is within the protection scope of the present application.

Where, the distance H₆ between the eighth edge 1332 and the second edge 122 may be obtained by measuring the distances between the eighth edge 1332 and the second edge 122 at different positions multiple times with a measuring tool and calculating an average value. The measuring tool may be any one of a straightedge or a vernier caliper, but is not limited thereto.

In the present application, by controlling the distance H₆ between the eighth edge 1332 and the second edge 122 within the range of 0.2-2 mm, an increase of the height occupied by the region of the active material on the negative electrode sheet, and an increase of the area of the active material on the negative electrode sheet can be further ensured under a given battery height, so as to improve the utilization rate of the active material in terms of the height space in the battery, thereby enhancing the energy density of the battery.

Further, in an embodiment of the present application, the distance Ha between the fifth edge 1131 and the seventh edge 1331 may be the same as or different from the distance H₅ between the sixth edge 1132 and the eighth edge 1332, which is not specifically limited in the present application, and may be specifically arranged according to the actual situation, as long as it does not affect the effects of the present application. In an embodiment, the distance Ha between the fifth edge 1131 and the seventh edge 1331 is the same as the distance H₅ between the sixth edge 1132 and the eighth edge 1332.

The distance H₄ between the seventh edge 1331 and the first edge 121 may be the same as or different from the distance H₆ between the eighth edge 1332 and the second edge 122, which is not specifically limited in the present application, and may be specifically arranged according to the actual situation, as long as it does not affect the effects of the present application. In an embodiment, the distance H₄ between the seventh edge 1331 and the first edge 121 is the same as the distance H₆ between the eighth edge 1332 and the second edge 122.

In an embodiment of the present application, the battery cell 100 also includes an electrolytic solution, and the electrolytic solution is accommodated in the housing and soaks the electrode assembly. The electrolytic solution used in the battery cell 100 of the present application includes an electrolyte and a solvent for dissolving the electrolyte.

There is no particular restriction on the electrolyte in the present application, and any substance known as an electrolyte may be used arbitrarily, as long as it does not impair the effects of the present application. In one embodiment, the electrolyte includes, but is not limited to, LiPF₆.

As the same time, the content of electrolyte in the present application is not specifically limited, as long as it does not impair the effects of the present application. For example, it may be 0.8-2.2 mol/L.

There is no particular restriction on the solvent in the present application, and any substance known as the solvent may be used arbitrarily, as long as it does not impair the effects of the present application. In one embodiment, the solvent includes, but is not limited to, ethylene carbonate (EC), propylene carbonate (PC), diethyl carbonate (DEC), ethyl methyl carbonate (EMC), dimethyl carbonate (DMC), butylene carbonate (BC) and methyl ethylene carbonate (MEC). The above solvents may be used alone or in any combination.

On the other hand, the present application also provides a battery module, including: a box body; and the battery cell as described in any of the above items, where the battery cell is accommodated in the box body.

Specifically, the battery module may be a battery sub-module or a battery pack.

On the other hand, in an embodiment of the present application, the present application further provides an electric apparatus, including the battery module as described above, and the battery module serves as a power supply for the electric apparatus. The electric apparatus may be, but is not limited to, a mobile device (e.g., mobile phone, laptop computer, etc.), an electric vehicle (e.g., pure electric vehicle, hybrid electric vehicle, plug-in hybrid electric vehicle, electric bicycle, electric scooter, electric golf cart, electric truck, etc.), an electric train, a ship and a satellite, an energy storage system, and the like.

Below, lithium-ion battery is taken as an example, and the preparation of lithium-ion battery is described in conjunction with specific examples. Those skilled in the art will understand that the preparation method described in the present application is merely an example, and any other suitable preparation method is within the scope of the present application.

The following describes the performance evaluation of the examples and comparative examples of the lithium-ion batteries according to the present application.

### Example 1

### I. Preparation of Lithium-Ion Battery

### 1. Preparation of a Positive Electrode Sheet

A positive electrode active material: lithium iron phosphate, a conductive agent: conductive carbon black SP, and a binder: PVDF, were mixed in a mass ratio of 97:0.7:2.3, and then NMP was added as a solvent for mixing. After stirring for a certain period of time, a uniform positive electrode slurry with a certain fluidity was obtained; the positive electrode slurry was evenly coated on both sides of a carbon-coated aluminum foil which served as the positive electrode substrate; and then the aluminum foil coated was transferred to an oven at 120° C. for drying, and then subjected to rolling, slitting, and cutting to obtain the positive electrode sheet.

### 2. Preparation of a Negative Electrode Sheet

A negative electrode active material: graphite, a conductive agent: conductive carbon black SP, a thickener: CMC, and a binder: SBR, were mixed in a mass ratio of 96.5:0.5:1.2:1.8, and then deionized water was added as a solvent for mixing. After stirring for a certain period of time, a uniform negative electrode slurry with a certain fluidity was obtained; the negative electrode slurry was evenly coated on both sides of a copper foil which served as the negative electrode substrate, and then the copper foil coated was transferred to an oven at 110° C. for drying, and then subjected to rolling, slitting, and cutting to obtain the negative electrode sheet.

### 3. Preparation of an Electrolytic Solution

Ethylene carbonate (EC), ethyl methyl carbonate (EMC) and diethyl carbonate (DEC) were mixed in a volume ratio of 1:1:1, and then 1 mol/L LiPF₆ was added and mixed evenly to obtain the electrolytic solution.

### 4. Preparation of a Separator

A PP membrane was used as the separator.

### 5. Preparation of a Lithium-Ion Battery

The negative electrode sheet and the positive electrode sheet prepared by the above steps were dried and then used together with the separator to prepare a wound cell core using a winding machine. A positive electrode tab and a negative electrode tab were welded to the top cover of the cell core, and the cell core with the top cover after welding was placed into an aluminum housing for packaging; and the lithium-ion battery was obtained by the electrolytic solution injection and formation, capacity grading.

Where, the distance H₁ between the first edge 121 and the fourth edge 1311 is 0.1 mm, the distance H₂ between the second edge 122 and the third edge 1111 is 0.3 mm, with a difference H₂-H₁ between H₂ and H₁ being 0.2 mm; the distance Ha between the fifth edge 1131 and the seventh edge 1331 is 0.1 mm; the distance H₄ between the seventh edge 1331 and the first edge 121 is 0.1 mm; the distance H₅ between the sixth edge 1132 and the eighth edge 1332 is 0.1 mm; and the distance H₆ between the eighth edge 1332 and the second edge 122 is 0.1 mm.

### II. Test Method

### 1. Test Method for Energy Density of Lithium-Ion Battery

The lithium-ion battery is placed at 25° C. for 30 minutes, fully charged at 1 C and fully discharged at 1 C, and the actual discharge energy is recorded; the lithium-ion battery is weighed using an electronic balance; the ratio of the actual discharge energy at 1 C to the weight is the actual energy density of the lithium-ion battery.

### Example 2

A lithium-ion battery is prepared according to the method of Example 1, and at the same time, the lithium-ion battery is tested according to the test method in Example 1, except for the following differences:
the distance H₁ between the first edge 121 and the fourth edge 1311 is 0.2 mm, the distance H₂ between the second edge 122 and the third edge 1111 is 0.7 mm, and the difference H₂-H₁ between H₂ and H₁ is 0.5 mm.

### Example 3

A lithium-ion battery is prepared according to the method of Example 1, and at the same time, the lithium-ion battery is tested according to the test method in Example 1, except for the following differences:
the distance H₁ between the first edge 121 and the fourth edge 1311 is 0.3 mm, the distance H₂ between the second edge 122 and the third edge 1111 is 1.05 mm, and the difference H₂-H₁ between H₂ and H₁ is 0.75 mm.

### Example 4

A lithium-ion battery is prepared according to the method of Example 1, and at the same time, the lithium-ion battery is tested according to the test method in Example 1, except for the following differences:
the distance H₁ between the first edge 121 and the fourth edge 1311 is 1 mm, the distance H₂ between the second edge 122 and the third edge 1111 is 2 mm, and the difference H₂-H₁ between H₂ and H₁ is 1 mm.

### Example 5

A lithium-ion battery is prepared according to the method of Example 1, and at the same time, the lithium-ion battery is tested according to the test method in Example 1, except for the following differences:
the distance H₁ between the first edge 121 and the fourth edge 1311 is 1.25 mm, the distance H₂ between the second edge 122 and the third edge 1111 is 2.5 mm, and the difference H₂-H₁ between H₂ and H₁ is 1.25 mm.

### Example 6

A lithium-ion battery is prepared according to the method of Example 1, and at the same time, the lithium-ion battery is tested according to the test method in Example 1, except for the following differences:
the distance H₁ between the first edge 121 and the fourth edge 1311 is 1.5 mm, the distance H₂ between the second edge 122 and the third edge 1111 is 3 mm, and the difference H₂
H₁ between H₂ and H₁ is 1.5 mm.

### Example 7

A lithium-ion battery is prepared according to the method of Example 1, and at the same time, the lithium-ion battery is tested according to the test method in Example 1, except for the following differences:
the distance H₁ between the first edge 121 and the fourth edge 1311 is 1.75 mm, the distance H₂ between the second edge 122 and the third edge 1111 is 2.75 mm, and the difference H₂-H₁ between H₂ and H₁ is 1 mm.

### Example 8

A lithium-ion battery is prepared according to the method of Example 1, and at the same time, the lithium-ion battery is tested according to the test method in Example 1, except for the following differences:
the distance H₁ between the first edge 121 and the fourth edge 1311 is 2 mm, the distance H₂ between the second edge 122 and the third edge 1111 is 5 mm, and the difference H₂
H₁ between H₂ and H₁ is 3 mm.

### Example 9

A lithium-ion battery is prepared according to the method of Example 1, and at the same time, the lithium-ion battery is tested according to the test method in Example 1, except for the following differences:
the distance H₁ between the first edge 121 and the fourth edge 1311 is 2.5 mm, the distance H₂ between the second edge 122 and the third edge 1111 is 6.5 mm, and the difference H₂-H₁ between H₂ and H₁ is 4 mm.

### Example 10

A lithium-ion battery is prepared according to the method of Example 1, and at the same time, the lithium-ion battery is tested according to the test method in Example 1, except for the following differences:
the distance H₁ between the first edge 121 and the fourth edge 1311 is 3 mm, the distance H₂ between the second edge 122 and the third edge 1111 is 8 mm, and the difference H₂-H₁ between H₂ and H₁ is 5 mm.

In the Examples 1 to 10, the corresponding lithium-ion batteries can be obtained by adjusting the distance H₁ between the first edge 121 and the fourth edge 1311 and the distance H₂ between the second edge 122 and the third edge 1111.

### Example 11

A lithium-ion battery is prepared according to the method of Example 1, and at the same time, the lithium-ion battery is tested according to the test method in Example 1, except for the following differences:
the distance H₅ between the fifth edge 1131 and the seventh edge 1331 is 0.2 mm, the distance H₄ between the seventh edge 1331 and the first edge 121 is 0.2 mm, the distance H₅ between the sixth edge 1132 and the eighth edge 1332 is 0.2 mm, and the distance H₆ between the eighth edge 1332 and the second edge 122 is 0.2 mm.

### Example 12

A lithium-ion battery is prepared according to the method of Example 1, and at the same time, the lithium-ion battery is tested according to the test method in Example 1, except for the following differences:
the distance H₅ between the fifth edge 1131 and the seventh edge 1331 is 0.5 mm, the distance H₄ between the seventh edge 1331 and the first edge 121 is 0.5 mm, the distance H₅ between the sixth edge 1132 and the eighth edge 1332 is 0.5 mm, and the distance H₆ between the eighth edge 1332 and the second edge 122 is 0.5 mm.

### Example 13

A lithium-ion battery is prepared according to the method of Example 1, and at the same time, the lithium-ion battery is tested according to the test method in Example 1, except for the following differences:
the distance H₃ between the fifth edge 1131 and the seventh edge 1331 is 1 mm, the distance H₄ between the seventh edge 1331 and the first edge 121 is 1 mm, the distance H₅ between the sixth edge 1132 and the eighth edge 1332 is 1 mm, and the distance H₆ between the eighth edge 1332 and the second edge 122 is 1 mm.

### Example 14

A lithium-ion battery is prepared according to the method of Example 1, and at the same time, the lithium-ion battery is tested according to the test method in Example 1, except for the following differences:
the distance H₅ between the fifth edge 1131 and the seventh edge 1331 is 1.5 mm, the distance H₄ between the seventh edge 1331 and the first edge 121 is 1.5 mm, the distance H₅ between the sixth edge 1132 and the eighth edge 1332 is 1.5 mm, and the distance H₆ between the eighth edge 1332 and the second edge 122 is 1.5 mm.

### Example 15

A lithium-ion battery is prepared according to the method of Example 1, and at the same time, the lithium-ion battery is tested according to the test method in Example 1, except for the following differences:
the distance H₃ between the fifth edge 1131 and the seventh edge 1331 is 2 mm, the distance H₄ between the seventh edge 1331 and the first edge 121 is 2 mm, the distance H₅ between the sixth edge 1132 and the eighth edge 1332 is 2 mm, and the distance H₆ between the eighth edge 1332 and the second edge 122 is 2 mm.

### Example 16

A lithium-ion battery is prepared according to the method of Example 1, and at the same time, the lithium-ion battery is tested according to the test method in Example 1, except for the following differences:
the distance H₅ between the fifth edge 1131 and the seventh edge 1331 is 2.25 mm, the distance H₄ between the seventh edge 1331 and the first edge 121 is 2.25 mm, the distance H₅ between the sixth edge 1132 and the eighth edge 1332 is 2.25 mm, and the distance H₆ between the eighth edge 1332 and the second edge 122 is 2.25 mm.

### Example 17

A lithium-ion battery is prepared according to the method of Example 1, and at the same time, the lithium-ion battery is tested according to the test method in Example 1, except for the following differences:
the distance H₃ between the fifth edge 1131 and the seventh edge 1331 is 2.5 mm, the distance H₄ between the seventh edge 1331 and the first edge 121 is 2.5 mm, the distance H₅ between the sixth edge 1132 and the eighth edge 1332 is 2.5 mm, and the distance H₆ between the eighth edge 1332 and the second edge 122 is 2.5 mm.

### Example 18

A lithium-ion battery is prepared according to the method of Example 1, and at the same time, the lithium-ion battery is tested according to the test method in Example 1, except for the following differences:
the distance H₅ between the fifth edge 1131 and the seventh edge 1331 is 2.75 mm, the distance H₄ between the seventh edge 1331 and the first edge 121 is 2.75 mm, the distance H₅ between the sixth edge 1132 and the eighth edge 1332 is 2.75 mm, and the distance H₆ between the eighth edge 1332 and the second edge 122 is 2.75 mm.

### Example 19

A lithium-ion battery is prepared according to the method of Example 1, and at the same time, the lithium-ion battery is tested according to the test method in Example 1, except for the following differences:
the distance H₃ between the fifth edge 1131 and the seventh edge 1331 is 3 mm, the distance H₄ between the seventh edge 1331 and the first edge 121 is 3 mm, the distance H₅ between the sixth edge 1132 and the eighth edge 1332 is 3 mm, and the distance H₆ between the eighth edge 1332 and the second edge 122 is 3 mm.

In the Examples 11 to 19, the corresponding lithium-ion batteries can be obtained by adjusting the distance H₃ between the fifth edge 1131 and the seventh edge 1331, the distance H₄ between the seventh edge 1331 and the first edge 121, the distance H₅ between the sixth edge 1132 and the eighth edge 1332, and the distance H₆ between the eighth edge 1332 and the second edge 122.

### Comparative Example 1

A lithium-ion battery is prepared according to the method of Example 1, and at the same time, the lithium-ion battery is tested according to the test method in Example 1, except for the following differences:
the distance H₁ between the first edge 121 and the fourth edge 1311 is 0, the distance H₂ between the second edge 122 and the third edge 1111 is 0, and the difference H₂-H₁ between H₂ and H is 0.

### Comparative Example 2

A lithium-ion battery is prepared according to the method of Example 1, and at the same time, the lithium-ion battery is tested according to the test method in Example 1, except for the following differences:
the distance H₁ between the first edge 121 and the fourth edge 1311 is 2 mm, the distance H₂ between the second edge 122 and the third edge 1111 is 2 mm, and the difference H₂ and H₁ is 0 mm.

### Comparative Example 3

A lithium-ion battery is prepared according to the method of Example 1, and at the same time, the lithium-ion battery is tested according to the test method in Example 1, except for the following differences:
the distance H₁ between the first edge 121 and the fourth edge 1311 is 5 mm, the distance H₂ between the second edge 122 and the third edge 1111 is 12 mm, and the difference H₂-H₁ between H₂ and H₁ is 7 mm.

### Comparative Example 4

A lithium-ion battery is prepared according to the method of Example 1, and at the same time, the lithium-ion battery is tested according to the test method in Example 1, except for the following differences:
the distance H₃ between the fifth edge 1131 and the seventh edge 1331 is 0 mm, the distance H₄ between the seventh edge 1331 and the first edge 121 is 0 mm, the distance H₅ between the sixth edge 1132 and the eighth edge 1332 is 0 mm, and the distance H₆ between the eighth edge 1332 and the second edge 122 is 0 mm.

### Comparative Example 5

A lithium-ion battery is prepared according to the method of Example 1, and at the same time, the lithium-ion battery is tested according to the test method in Example 1, except for the following differences:
the distance H₅ between the fifth edge 1131 and the seventh edge 1331 is 4 mm, the distance H₄ between the seventh edge 1331 and the first edge 121 is 4 mm, the distance H₅ between the sixth edge 1132 and the eighth edge 1332 is 4 mm, and the distance H₆ between the eighth edge 1332 and the second edge 122 is 4 mm.

### III. Test Results

TABLE 1
Parameters of Examples 1-10, Parameters of
Comparative Examples 1-3, and Test Results

| | H₁ | H₂ | H₂ − H₁ | Energy density (Wh/L) |
|---|---|---|---|---|
| Example 1 | 0.1 | 0.3 | 0.2 | 826 |
| Example 2 | 0.2 | 0.7 | 0.5 | 821 |
| Example 3 | 0.3 | 1.05 | 0.75 | 818 |
| Example 4 | 1 | 2 | 1 | 803 |
| Example 5 | 1.25 | 2.5 | 1.25 | 796 |
| Example 6 | 1.5 | 3 | 1.5 | 790 |
| Example 7 | 1.75 | 2.75 | 2 | 790 |
| Example 8 | 2 | 5 | 3 | 768 |
| Example 9 | 2.5 | 6.5 | 4 | 750 |
| Example 10 | 3 | 8 | 5 | 732 |
| Comparative | 0 | 0 | 0 | 700 |
| Example 1 | | | | |
| Comparative | 2 | 2 | 0 | 667 |
| Example 2 | | | | |
| Comparative | 5 | 12 | 7 | 560 |
| Example 3 | | | | |

Analysis of results: when the distance H₁ between the first edge 121 and the fourth edge 1311 is controlled within the range of 0-3 mm, the distance H₂ between the second edge 122 and the third edge 1111 is controlled within the range of 0-8 mm, and the difference H₂-H₁ between H₂ and H₁ is controlled within the range of 0.2-5 mm, the energy density of the lithium-ion battery can be significantly improved.

On this basis, when the distance H₁ between the first edge 121 and the fourth edge 1311 is controlled within the range of 0-1.5 mm, the distance H₂ between the second edge 122 and the third edge 1111 is controlled within the range of 0-3 mm, and the difference H₂-H₁ between H₂ and H₁ is controlled within the range of 0.5-1.5 mm, the energy density of the lithium-ion battery can be further improved.

Compared with the comparative examples, the energy density of the present application at 25° C. is significantly improved.

TABLE 2
Parameters of Example 1, Examples 11-19, and
Comparative Examples 4-5, and Test Results

| | H₃ | H₄ | H₅ | H₆ | Energy density (Wh/L) |
|---|---|---|---|---|---|
| Example 1 | 0.1 | 0.1 | 0.1 | 0.1 | 826 |
| Example 11 | 0.2 | 0.2 | 0.2 | 0.2 | 831 |
| Example 12 | 0.5 | 0.5 | 0.5 | 0.5 | 844 |
| Example 13 | 1 | 1 | 1 | 1 | 851 |
| Example 14 | 1.5 | 1.5 | 1.5 | 1.5 | 842 |
| Example 15 | 2 | 2 | 2 | 2 | 835 |
| Example 16 | 2.25 | 2.25 | 2.25 | 2.25 | 823 |
| Example 17 | 2.5 | 2.5 | 2.5 | 2.5 | 819 |
| Example 18 | 2.75 | 2.75 | 2.75 | 2.75 | 804 |
| Example 19 | 3 | 3 | 3 | 3 | 799 |
| Comparative | 0 | 0 | 0 | 0 | 700 |
| Example 4 | | | | | |
| Comparative | 4 | 4 | 4 | 4 | 568 |
| Example 5 | | | | | |

Analysis of results: when the distance H₃ between the fifth edge 1131 and the seventh edge 1331 is controlled within the range of 0-3 mm, the distance H₄ between the seventh edge 1331 and the first edge 121 is controlled within the range of 0-3 mm, the distance H₅ between the sixth edge 1132 and the eighth edge 1332 is controlled within the range of 0-3 mm, and the distance H₆ between the eighth edge 1332 and the second edge 122 is controlled within the range of 0-3 mm, the energy density of the lithium-ion battery can be significantly improved.

On this basis, when the distance H₃ between the fifth edge 1131 and the seventh edge 1331 is controlled within the range of 0.2-2 mm, the distance H₄ between the seventh edge 1331 and the first edge 121 is controlled within the range of 0.2-2 mm, the distance H₅ between the sixth edge 1132 and the eighth edge 1332 is controlled within the range of 0.2-2 mm, and the distance H₆ between the eighth edge 1332 and the second edge 122 is controlled within the range of 0.2-2 mm, the energy density of the lithium-ion battery can be further improved.

Compared with the comparative examples, the energy density of the present application at 25° C. is significantly improved.

The introduction provided in the above steps is only used to help understand the method, structure and core idea of the present application. For those skilled in the art, without departing from the principles of the present application, several improvements and modifications can also be made to the present application, and these improvements and modifications also fall within the scope of protection of the claims of the present application.

In the above description, specific features, structures, materials or characteristics may be combined in an appropriate manner in any one or more embodiments or examples.

The introduction provided in the above steps is only used to help understand the method, structure and core idea of the present application. For those skilled in the art, without departing from the principles of the present application, several improvements and modifications can also be made to the present application, and these improvements and modifications also fall within the scope of protection of the embodiments of the present application.

What is claimed is:

1. A battery cell, having a first direction and comprising:
a housing; and
an electrode assembly, accommodated in the housing;
wherein the electrode assembly comprises: a positive electrode sheet, a separator and a negative electrode sheet which are arranged to be mutually stacked; the separator is arranged between the positive electrode sheet and the negative electrode sheet, and the separator is provided with a first edge and a second edge arranged opposite to each other in the first direction;
the positive electrode sheet is connected to a positive electrode tab; and the negative electrode sheet is connected to a negative electrode tab;
wherein the positive electrode tab is provided with a third edge away from the positive electrode sheet in the first direction, and the first edge is farther away from the third edge than the second edge;
the negative electrode tab is provided with a fourth edge away from the negative electrode sheet in the first direction, and the second edge is farther away from the fourth edge than the first edge; and
in the first direction, a distance between the first edge and the fourth edge is H₁ mm, and a distance between the second edge and the third edge is H₂ mm, satisfying: H₁<H₂.

2. The battery cell according to claim 1, wherein the distance H₁ mm between the first edge and the fourth edge and the distance H₂ mm between the second edge and the third edge further satisfy: 0.2≤H₂-H₁≤5.

3. The battery cell according to claim 2, wherein the distance H₁ mm between the first edge and the fourth edge and the distance H₂ mm between the second edge and the third edge further satisfy: 0.5≤H₂-H₁≤1.5.

4. The battery cell according to claim 1, wherein the distance H₁ mm between the first edge and the fourth edge further satisfies: 0<H₁≤3.

5. The battery cell according to claim 2, wherein the distance H₁ mm between the first edge and the fourth edge further satisfies: 0<H₁≤3.

6. The battery cell according to claim 3, wherein the distance H₁ mm between the first edge and the fourth edge further satisfies: 0<H₁≤3.

7. The battery cell according to claim 4, wherein the distance H₁ mm between the first edge and the fourth edge further satisfies: 0<H₁≤1.5.

8. The battery cell according to claim 5, wherein the distance H₁ mm between the first edge and the fourth edge further satisfies: 0<H₁≤1.5.

9. The battery cell according to claim 1, wherein the distance H₂ mm between the second edge and the third edge further satisfies: 0<H₂≤8.

10. The battery cell according to claim 2, wherein the distance H₂ mm between the second edge and the third edge further satisfies: 0<H₂≤8.

11. The battery cell according to claim 3, wherein the distance H₂ mm between the second edge and the third edge further satisfies: 0<H₃≤8.

12. The battery cell according to claim 9, wherein the distance H₂ mm between the second edge and the third edge further satisfies: 0<H₂≤3.

13. The battery cell according to claim 10, wherein the distance H₂ mm between the second edge and the third edge further satisfies: 0<H₂≤3.

14. The battery cell according to claim 1, wherein the positive electrode sheet comprises: a positive electrode substrate, and a positive electrode active material layer arranged on the positive electrode substrate;
the negative electrode sheet comprises: a negative electrode substrate, and a negative electrode active material layer arranged on the negative electrode substrate;
the positive electrode active material layer is provided with a fifth edge away from the positive electrode tab in the first direction, and the negative electrode active material layer is provided with a seventh edge away from the positive electrode tab in the first direction;
a distance between the fifth edge and the seventh edge is H₃ mm, satisfying: 0<H₃≤3;
a distance between the seventh edge and the first edge is H₄ mm, satisfying: 0<H₄≤3.

15. The battery cell according to claim 14, wherein the distance H₃ mm between the fifth edge and the seventh edge further satisfies: 0.2≤H₃≤2; and
the distance H₄ mm between the seventh edge and the first edge further satisfies: 0.2≤H₄≤2.

16. The battery cell according to claim 14, wherein the positive electrode active material layer is further provided with a sixth edge close to the positive electrode tab in the first direction;
the negative electrode active material layer is further provided with an eighth edge close to the positive electrode tab in the first direction;
a distance between the sixth edge and the eighth edge is H₅ mm, satisfying: 0<H₅≤3;
a distance between the eighth edge and the second edge is H₆ mm, satisfying: 0<H₆≤3.

17. The battery cell according to claim 16, wherein the distance H₅ mm between the sixth edge and the eighth edge further satisfies: 0.2≤H₅≤2; and
the distance H₆ mm between the eighth edge and the second edge further satisfies: 0.2≤H₆≤2.

18. A battery module comprising: a box body; and the battery cell according to claim 1, wherein the battery cell is accommodated in the box body.
